(19) United States
(12) Patent Application Publication
(10) Pub. No.: US 2016/0292378 A1
(43) Pub. Date: Oct. 6, 2016

(54) TELEMEDICINE SYSTEM INCLUDING PRESCRIPTION DELIVERY

(71) Applicant: MendGroup, Inc., Seattle, WA (US)

(72) Inventor: Adnan Saric, Seattle, WA (US)

(21) Appl. No.: 15/085,645

(22) Filed: Mar. 30, 2016

Related U.S. Application Data
(60) Provisional application No. 62/140,378, filed on Mar. 30, 2015.

(51) Int. Cl. G06F 19/00

(52) U.S. Cl. CPC G06F 19/3418; G06F 19/3456

(57) ABSTRACT

A prescription delivery computing system determines whether one or more prescriptions are respectively eligible to be delivered to the patient, the one or more prescriptions resultant from a telemedicine session conducted between a patient and a health care provider via a first patient computing device and a health care provider computing system; for the one or more prescriptions that are eligible to be delivered to the patient, obtains a price quote for delivery services to deliver the one or more prescriptions from a pharmacy to the patient, the price quote obtained from a delivery service computing system; provides the price quote for the delivery services to the patient for approval; responsive to receiving patient input data indicative of patient approval of the price quote for the delivery services, arranges for the delivery services to be performed; and transmits data that describes the one or more prescriptions to the pharmacy.

### BACKGROUND

1. Technical Field

The present disclosure generally relates to telemedicine systems. More particularly, the present disclosure relates to prescription delivery in a telemedicine system.

2. Description of the Related Art

In a traditional health care scenario, a patient physically visits a health care provider's place of business and one or more health care services are performed by the health care provider. Depending on an outcome of the provided services, the health care provider may provide a prescription for the patient. The health care provider may physically create the prescription (e.g., a printed or hand-written sheet with health care provider signature) and provide it to the patient. The patient can physically visit a pharmacy and present the prescription to have the prescription filled. Alternatively, the health care provider may contact the pharmacy (e.g., by telephone) on behalf of the patient and then the patient physically visits the pharmacy to retrieve the filled prescription.

With the advancement of telecommunication and information technologies, telemedicine or telehealth systems now enable the patient and health care provider to interface remotely, thereby reducing costs associated with transportation, waiting periods, office space, and other items required for a face-to-face visit. In addition, telemedicine systems provide access to services that might not otherwise be available to the patient due to, for example, lack of qualified local health care providers or patient immobility.

### BRIEF SUMMARY

The traditional scenario for obtaining prescriptions described above fails to properly accommodate sick, weakened, or otherwise immobile patients. In particular, a sick or immobile patient may be unable or unwilling to leave their home to physically visit a pharmacy. Even if such patient is able to visit the pharmacy, such visitation is undesirable as it increases the potential for spread of illness from the patient to others present at the pharmacy.

Similar considerations are applicable to a caretaker who is caring for a sick patient. For example, a parent caring for their ill child would greatly prefer to not be required to leave the child to physically visit the pharmacy and obtain the prescribed medications.

In addition, in the telemedicine context, requiring the patient to physically visit the pharmacy runs counter to the principles that make telemedicine an attractive option in the first place. For example, for a patient that is immobile or lacks means of transportation, telemedicine systems that do not feature prescription delivery provide incomplete care and, therefore, may be unable to actually serve their intended purpose.

Another problem faced by telemedicine systems is that health care providers such as physicians are unable to provide medications directly to the patient, as they would be able to do in a face-to-face context. Therefore, the use of pharmacy-filled prescriptions may actually be higher in telemedicine treatment versus traditional face-to-face treatment.

As another example, telemedicine systems may enable the health care provider to conduct treatment for patients spanning a diverse geographic area. Rules or laws regarding prescriptions may vary greatly across such geographic area and, therefore, the health care provider may be undesirably required to spend additional time researching the prescription laws of various jurisdictions instead of providing health care treatment.

Thus, the use of telemedicine systems to provide health care services has created new problems rooted in technology, particularly in the realm of medication prescription. In particular, in current systems, multiple human users are required to engage with multiple different computer systems or entities in order to perform prescription delivery. The use of telemedicine systems also presents new challenges relating to fraud detection and prevention which did not exist in traditional health care scenarios, due to the in-person or face-to-face nature of conventional health care visits.

Therefore, a telemedicine system that performs streamlined and user-friendly prescription delivery while preventing or reducing the occurrence of fraud is desirable.

A computer-implemented method in a telemedicine system that includes at least a first patient computing device, a health care provider computing system, and a prescription delivery computing system that includes at least one processor, may be summarized as including: receiving, by the prescription delivery computing system from the health care provider computing system, data that identifies one or more prescriptions issued by a health care provider that operates the health care provider computing system to a patient that operates the first patient computing device, the one or more prescriptions resultant from a live telemedicine session conducted between the patient and the health care provider via the first patient computing device and the health care provider computing system; receiving, by the prescription delivery computing system, data that verifies whether the telemedicine session occurred between the patient and the health care provider; determining, by the prescription delivery computing system, whether the one or more prescriptions are respectively eligible to be delivered to the patient based at least in part on the received data that verifies whether the telemedicine session occurred between the patient and the health care provider; for the one or more prescriptions that are eligible to be delivered to the patient, obtaining, by the prescription delivery computing system, a price quote for delivery services to deliver the one or more prescriptions from a pharmacy to the patient, the price quote obtained from a delivery service computing system; providing, by the prescription delivery computing system, the price quote for the delivery services to the patient computing device for approval by the patient; responsive to receiving patient input data indicative of patient approval of the price quote for the delivery services, arranging, by the prescription delivery computing system, for the delivery services to be performed; and transmitting, by the prescription delivery computing system, data that describes the one or more prescriptions to the pharmacy.

Receiving information that verifies whether the telemedicine session occurred between the patient and the health care provider may include receiving information which indicates an occurrence of a real-time communication between the patient computing device and the health care provider computing system. The computer-implemented method may further include: receiving, by the prescription delivery computing system, data that identifies a current geographical location of the patient computing device, wherein, determining whether the one or more prescriptions are respectfully eligible to be delivered to the patient includes determining whether the one or more prescriptions are respectfully eligible to be delivered to the patient based at least in part on the received data that identifies the current geographical location of the patient computing device. Receiving data that identifies a current geographical location of the patient computing device may include receiving information relating to one or more of an Internet Protocol (IP) address, a media access control (MAC) address, an RFID identifier, a hardware embedded identifier, a software embedded identifier, Wi-Fi® location data, cell tower location data, a device fingerprint, or device GPS data. The computer-implemented method may further include: providing, by the health care provider computing system, a menu of available medications to the health care provider at least one of during and after the telemedicine session. The computer-implemented method may further include: determining, by the prescription delivery computing system, whether the one or more prescriptions conflict with one or more of allergies associated with the patient, existing medications of the patient, and concurrently prescribed medications of the patient; and when it is determined that the one or more prescriptions conflict with one or more of allergies associated with the patient, existing medications of the patient, and concurrently prescribed medications of the patient, providing, by the prescription delivery computing system, an alert to the health care provider computing system. The computer-implemented method may further include: receiving, by the prescription delivery computing system, patient input data that identifies the pharmacy. The computer-implemented method may further include: identifying, by the prescription delivery computing system, a preferred pharmacy for the patient; and receiving, by the prescription delivery computing system, patient input data that confirms the preferred pharmacy. Identifying, by the prescription delivery computing system, a preferred pharmacy for the patient may include identifying, by the prescription delivery computing system, a previously used pharmacy for the patient. Identifying, by the prescription delivery computing system, a preferred pharmacy for the patient may include identifying, by the prescription delivery computing system, one or more local pharmacies based at least in part on a patient address or a current location of the patient computing device. Identifying, by the prescription delivery computing system, a preferred pharmacy for the patient may include querying, by the prescription delivery computing system, a patent account database to identify the preferred pharmacy stored in a patient account associated with the patient. Obtaining, by the prescription delivery computing system, a price quote for delivery services to deliver the one or more prescriptions from a pharmacy to the patient may include communicating, by the prescription delivery computing system, in real-time with a delivery service computing system to obtain the price quote for the delivery services. Determining, by the prescription delivery computing system, whether the one or more prescriptions are respectively eligible to be delivered to the patient may include determining, by the prescription delivery computing system, a federal scheduling level of each of the one or more prescriptions. Determining, by the prescription delivery computing system, whether the one or more prescriptions are respectively eligible to be delivered to the patient may include determining, by the prescription delivery computing system, a narcotic classification of each of the one or more prescriptions. Determining, by the prescription delivery computing system, whether the one or more prescriptions are respectively eligible to be delivered to the patient may include querying, by the prescription delivery computing system, a database to determine an eligibility status for each of the one or more prescriptions. The computer-implemented method may further include: responsive to receiving patient input data indicative of patient disapproval of the price quote for the delivery services, transmitting, by the prescription delivery computing system, data that describes the one or more prescriptions to the pharmacy but not arranging, by the prescription delivery computing system, for the delivery services to be performed. The computer-implemented method may further include: serving, by the prescription delivery computing system, as an intermediary for at least one of a first transaction between the patient and the pharmacy and a second transaction between the patient and a delivery service that performs the delivery services. Obtaining, by the prescription delivery computing system, a price quote for delivery services to deliver the one or more prescriptions from a pharmacy to the patient may include using, by the prescription delivery computing system, an application programming interface to obtain the price quote for the delivery services from a delivery service server computing device. Receiving, by the prescription delivery computing system from the health care provider computing system, data that identifies one or more prescriptions issued by a health care provider may include receiving, by the prescription delivery computing system from the health care provider computing system, electronic records that identify the one or more prescriptions issued by a health care provider. The computer-implemented method may further include: transmitting, by the prescription delivery computing system to the patient computing device, data which indicates status information for the scheduled delivery service.

A telemedicine system may be summarized as including: at least a first patient computing device; a health care provider computing system; and a prescription delivery computing system that includes at least one processor and a non-transitory processor-readable medium that stores at least one of instructions or data that, when executed by the at least one processor, cause the prescription delivery computing system to: receive from the health care provider computing system data that identifies one or more prescriptions issued by a health care provider that operates the health care provider computing system to a patient that operates the first patient computing device, the one or more prescriptions resultant from a telemedicine session conducted between the patient and the health care provider via the first patient computing device and the health care provider computing system; receive data that verifies whether the telemedicine session occurred between the patient and the health care provider; determine whether the one or more prescriptions are respectively eligible to be delivered to the patient based at least in part on the received data that verifies whether the telemedicine session occurred between the patient and the health care provider; for the one or more prescriptions that are eligible to be delivered to the patient, obtain a price quote for delivery services to deliver the one or more prescriptions from a pharmacy to the patient, the price quote obtained from a delivery service computing system; provide the price quote for the delivery services to the patient for approval; responsive to receiving patient input data indicative of patient approval of the price quote for the delivery services, arrange for the delivery services to be performed; and transmit data that describes the one or more prescriptions to the pharmacy.

The instructions or data, when executed by the at least one processor, may cause the prescription delivery computing system to: receive information which indicates an occurrence of a real-time communication between the patient computing device and the health care provider computing system. The instructions or data, when executed by the at least one processor, may cause the prescription delivery computing system to: receive data that identifies a current geographical location of the patient computing device; and may determine whether the one or more prescriptions are respectfully eligible to be delivered to the patient based at least in part on the received data that identifies the current geographical location of the patient computing device. The instructions or data, when executed by the at least one processor, may cause the prescription delivery computing system to: receive information relating to one or more of an Internet Protocol (IP) address, a media access control (MAC) address, an RFID identifier, a hardware embedded identifier, a software embedded identifier, Wi-Fi® location data, cell tower location data, a device fingerprint, or device GPS data.

A prescription delivery computing system may be summarized as including: at least one processor; and a non-transitory processor-readable medium that stores at least one of instructions or data that, when executed by the at least one processor, cause the prescription delivery computing system to: receive from a health care provider computing system data that identifies one or more prescriptions issued by a health care provider that operates the health care provider computing system to a patient that operates a first patient computing device, the one or more prescriptions resultant from a telemedicine session conducted between the patient and the health care provider via the first patient computing device and the health care provider computing system; determine whether the one or more prescriptions are respectively eligible to be delivered to the patient; for the one or more prescriptions that are eligible to be delivered to the patient, obtain a price quote for delivery services to deliver the one or more prescriptions from a pharmacy to the patient, the price quote obtained from a delivery service computing system; provide the price quote for the delivery services to the patient for approval; responsive to receiving patient input data indicative of patient approval of the price quote for the delivery services, arrange for the delivery services to be performed; and transmit data that describes the one or more prescriptions to the pharmacy.

A computer-implemented method in a telemedicine system that includes at least a first patient computing device, a health care provider computing system, and a prescription delivery computing system that includes at least one processor, may be summarized as including: receiving, by the prescription delivery computing system from the health care provider computing system, data that identifies one or more prescriptions issued by a health care provider that operates the health care provider computing system to a patient that operates the first patient computing device, the one or more prescriptions resultant from a live telemedicine session conducted between the patient and the health care provider via the first patient computing device and the health care provider computing system; determining, by the prescription delivery computing system, whether the one or more prescriptions are respectively eligible to be delivered to the patient; for the one or more prescriptions that are eligible to be delivered to the patient, obtaining, by the prescription delivery computing system, a price quote for delivery services to deliver the one or more prescriptions from a pharmacy to the patient, the price quote obtained from a delivery service computing system; providing, by the prescription delivery computing system, the price quote for the delivery services to the patient computing device for approval by the patient; responsive to receiving patient input data indicative of patient approval of the price quote for the delivery services, arranging, by the prescription delivery computing system, for the delivery services to be performed; and transmitting, by the prescription delivery computing system, data that describes the one or more prescriptions to the pharmacy.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements, and may have been solely selected for ease of recognition in the drawings.

FIG. 1 is a block diagram of a telemedicine system that performs prescription delivery, according to at least one illustrated implementation.

FIGS. 2A-2B are a flow chart diagram showing a method to perform prescription delivery in a telemedicine system, according to at least one illustrated implementation.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures have not been shown or described in detail to avoid unnecessarily obscuring descriptions of the implementations.

Unless the context requires otherwise, throughout the specification and claims that follow, the word “comprising” is synonymous with “including,” and is inclusive or open-ended (i.e., does not exclude additional, unrecited elements or method acts).

Reference throughout this specification to “one implementation” or “an implementation” means that a particular feature, structure or characteristic described in connection with the implementation is included in at least one implementation. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

As used in this specification and the appended claims, the singular forms “a,” “an,” and “the” include plural referents unless the context clearly dictates otherwise. It should also be noted that the term “or” is generally employed in its broadest sense, that is, as meaning “and/or” unless the context clearly dictates otherwise.

The headings and Abstract of the Disclosure provided herein are for convenience only and do not interpret the scope or meaning of the implementations.

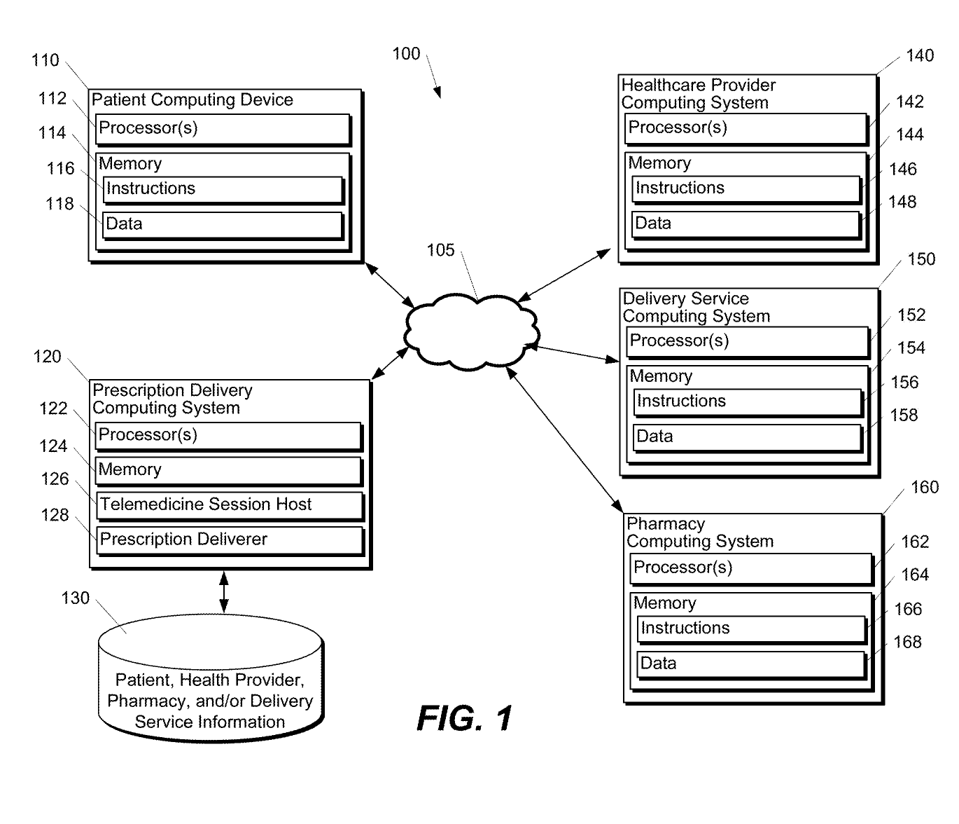

FIG. 1 is a block diagram of a telemedicine system 100 that performs prescription delivery, according to at least one illustrated implementation. Generally, the system 100 is organized in a distributed fashion in which a patient computing device 110, a prescription delivery computing system 120, a health care provider computing system 140, a delivery service computing system 150, and a pharmacy computing system 160 interact or otherwise communicate with each other via a communications network 105.

The system 100 can be used to enable telemedicine sessions between a patient that operates the patient computing device 110 and a health care provider that operates the health care provider computing system 140. For example, the prescription delivery computing system 120 can enable or host the telemedicine session conducted between the patient computing device 110 and a health care provider that operates the health care provider computing system 140. In addition, according to an aspect of the present disclosure, the prescription delivery computing system 120 performs prescription delivery in addition to enabling telemedicine sessions between patients and health care providers.

Although only a single patient computing device 110 is illustrated in FIG. 1, the system 100 can include any number of patient computing devices via which different patients interact with any number of health care providers. Likewise, although only a single health care provider computing system 140 is illustrated in FIG. 1, the system 100 can include any number of different health care provider computing systems 140 via which different health care providers interact with any number of patients. Likewise, although only a single delivery service computing system 150 is illustrated in FIG. 1, the system 100 can include any number of different delivery service computing systems 150 via which different delivery services may electronically provide price quotes. Likewise, although only a single pharmacy computing system 160 is illustrated in FIG. 1, the system 100 can include any number of different pharmacy computing systems 160 via which different pharmacies can electronically receive prescriptions for patients.

The patient computing device 110 can be any type of computing device that can engage in a telemedicine session. For example, the patient computing device 110 can be a laptop computer, personal computer, desktop computer, tablet computing device, smartphone, personal digital assistant, gaming console, videoconferencing system, portable media player, or other type of computing device.

The patient computing device 110 includes a processor 112 and a memory 114. The processor 112 can be one processor or a plurality of processors that are operatively coupled. The processor 112 can be any processing device, such as a microprocessor, microcontroller, integrated circuit, circuitry that implements computer logic, or some combination thereof. The memory 114 can include any non-transitory information storage device, including, but not limited to, RAM, ROM, hard drives, flash drives, optical media, other memory devices, or some combination thereof. The memory 114 can store information accessible by processor 112, including instructions 116 that can be executed by processor 112. The instructions 116 can be any set of instructions that when executed by the processor 112, cause the processor 112 to provide desired functionality. The memory 114 can also store data 118.

In some implementations, the memory 114 of the patient computing device 110 stores a downloadable application (i.e. “app”) that, when executed by the processor 112, controls communications between the patient computing device 110 and the prescription delivery computing system 120, the health care provider computing system 140, the delivery service computing system 150, and/or the pharmacy computing system 160. For example, the application may be designed and provided by an entity that operates the prescription delivery computing system 120.

The application may include instructions that cause the patient computing device 110 to engage in a telemedicine session or perform other operations such as receive and relay patient account information, prescription status information, or geo-location information, address information (e.g., internet protocol (IP) address of the patient computing device, mailing or business address of the patient), telemedicine session information (e.g., indication of the occurrence of a session, duration, images, video, audio), or other data between the patient computing device 110 and the prescription delivery computing system 120. The application may provide information to and receive information from the patient using one or more user interfaces.

Preferably, the patient computing device 110 includes one or more input/output components (not shown) that enable the telemedicine session to be conducted. For example, the patient computing device 110 can include one or more of speakers, a microphone, a display, a keyboard, a mouse, a camera, or other such devices that enable teleconferencing and/or videoconferencing.

The patient computing device 110 may include the ability to determine its geographic location using one or more location-identifying techniques, such as global positioning system (GPS), near field communications (NFC), cell tower identification, Internet Protocol (IP) address, media access control (MAC) address, RFID identifier, hardware embedded identifier, software embedded identifier, Wi-Fi® location data, device fingerprint, etc. In such implementations, the patient computing device 110 may include a GPS transceiver, RFID reader, or other components which enable the patient computing device to determine its geographic location. The memory 114 may include a location-determining module which identifies the location of the patient computing device 110 and processes the location information into a form which may be passed to other components of the system 100, such as the prescription delivery computing system 120.

The health care provider computing system 140, the delivery service computing system 150, and the pharmacy computing system 160 can each include a processor (142, 152, and 162, respectively) and a non-transitory memory (144, 154, and 164, respectively). Similar to processor 112 and memory 114, processors 142, 152, and 162 can respectively be any processing device or combination of such devices. Likewise, memory 144, memory 154, and memory 164 can respectively include any information storage device or combination of such devices. Each memory 144, 154, and 164 can store instructions (146, 156, and 166, respectively) and data (148, 158, and 168, respectively).

The health care provider computing system 140 can include one or more computing devices that are operatively connected. For example, the health care provider computing system 140 can be a computing system located at a hospital, a physician's office, a nursing facility, and/or other health care locations. Preferably, the health care provider computing system 140 includes one or more input/output components (not shown) that enable the telemedicine session to be conducted. For example, the health care provider computing system 140 can include one or more of speakers, a microphone, a display, a keyboard, a mouse, a camera, or other such devices that enable teleconferencing and/or videoconferencing.

In some implementations, a health information storage computing system (not shown) can also be connected to the network 105 and in communication with the various components of system 100. The health information storage computing system can include one or more computing devices that are operatively connected. For example, the health information storage computing system can include one or more server computing devices that provide access to a health information database over network 105. In some implementations, the health information storage computing system may be denominated as a cloud-based health storage system. The health information storage computing system can include multiple, separate storage systems. For example, in some implementations, the health information storage computing system can include the Microsoft HealthVault™ system and/or other similar systems.

The health information database can store health information associated with one or more patients. For example, the health information database can store medication information, health history, prescription history, allergy information, fitness information, blood pressure information, lab results, information about current and past conditions and illnesses, medical records such as physician notes, x-rays, scans, or other images. Such information may be accessible by or provided to one or both of the patient (via the patient computing device 110) and the health care provider (via the health care provider computing system 140) before, during, and/or after a telemedicine session conducted between the patient and the health care provider over network 105.

In some implementations, one or more medical or fitness devices (e.g., blood pressure monitors, glucose monitors, pulse monitors, oxygen sensors, step counters, scales, sleep monitoring devices, etc.) may be connected to the patient computing device 110 or connected (e.g., wirelessly) to the system 100 generally. Data generated by the one or more medical or fitness devices may be stored in the health information database and/or may be provided in real-time during a telemedicine session.

The delivery service computing system 150 includes one or more computing devices that are operatively connected. For example, the delivery service computing system 150 can include one or more server computing devices that enable provision of real-time delivery service price quotes over network 105 (e.g., using an application programming interface).

The pharmacy computing system 160 can include one or more computing devices that are operatively connected. In some implementations, the pharmacy computing system 160 includes one or more server computing devices that provide information using an application programming interface. For example, in some implementations, the pharmacy computing system 160 includes one or more server computing devices that are operable to provide real-time prescription status checks, accept electronic submission of prescriptions to the pharmacy, and/or other tasks (e.g., via an application programming interface).

In some implementations, the system 100 includes a pharmacy intermediary computing system (not shown) connected to network 105. The prescription delivery computing system 120 can cooperatively operate, instruct, or otherwise communicate with the pharmacy intermediary computing system to query or otherwise communicate with one or more pharmacy computing systems 160 on behalf of the prescription delivery computing system 120. In some implementations, prescription delivery computing system 120 can cooperatively operate, instruct, or otherwise communicate with a similar intermediary computing system to query or otherwise communicate with one or more delivery service computing systems 150 on behalf of the prescription delivery computing system 120.

Prescription delivery computing system 120 includes one or more computing devices that are operatively connected. In some implementations, the prescription delivery computing system 120 includes one or more server computing devices that are operatively connected. The server computing devices can be arranged according to any computer architecture, including parallel, sequential, and/or distributed computing architectures.

The server computing devices can interact with patient computing device 110, health care provider computing system 140, delivery service computing system 150, and/or pharmacy computing system 160 over network 105. For example, prescription delivery computing system 120 can communicate with patient computing device 110 via an application stored and locally executed at the patient computing device 110. As another example, the prescription delivery computing system 120 can communicate with health care provider computing system 140 using a web application. For example, health care provider computing system 140 can use a browser application to interact with or execute portions of the web application. Other structures or distributions of processing may be used as well.

The prescription delivery computing system 120 includes a processor 122 and a memory 124. The processor 122 can be one processor or a plurality of processors that are operatively coupled. The processor 122 can be any processing device, such as a microprocessor, microcontroller, integrated circuit, other device that implements computer logic, or some combination thereof. The memory 124 can include any non-transitory information storage device, including, but not limited to, RAM, ROM, hard drives, flash drives, optical media, other memory devices, or some combination thereof. The memory 124 can store information accessible by processor 122, including instructions that can be executed by processor 122. The instructions can be any set of instructions that when executed by the processor 122, cause the processor 122 to provide desired functionality. The memory 124 can also store data.

The prescription delivery computing system 120 includes a telemedicine session host 126, a prescription deliverer 128, and a database 130 that stores patient, health provider, pharmacy, and/or delivery service information (e.g., user account information, health care provider rosters, insurance plans accepted by each health care provider, prescription scheduling or classification, pharmacy rosters, formats for electronic submission of prescriptions to pharmacies, delivery service rosters, designated delivery zones, etc.).

The prescription delivery computing system 120 implements the telemedicine session host 126 to host or otherwise enable telemedicine sessions between the patient computing device 110 and the health care provider computing system 140. For example, prescription delivery computing system 120 can implement telemedicine session host 126 to provide video or audio conferencing functionality.

In some implementations, the patient computing device 110 and the health care provider computing system 140 communicate directly or via a peer-to-peer relay system and do not use a session host. In some implementations, prescription delivery computing system 120 does not include telemedicine session host 126. For example, prescription delivery computing system 120 may be used in a non-telemedicine context or a separate system may perform telemedicine session hosting.

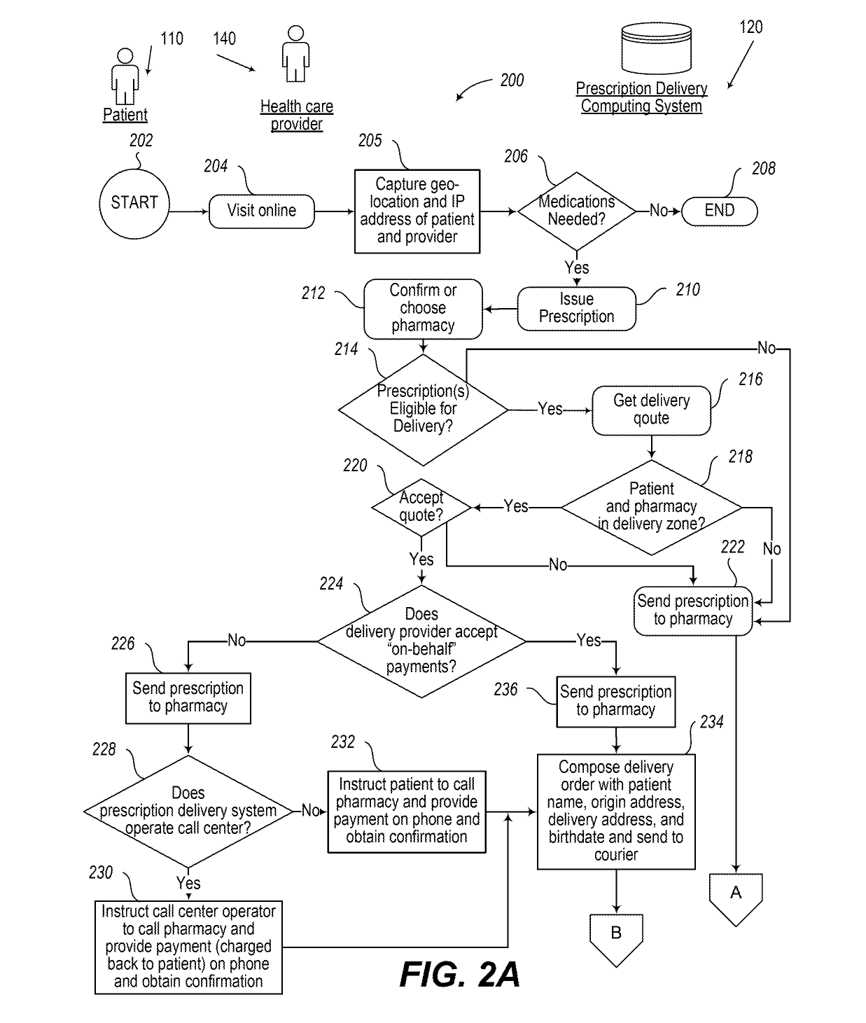

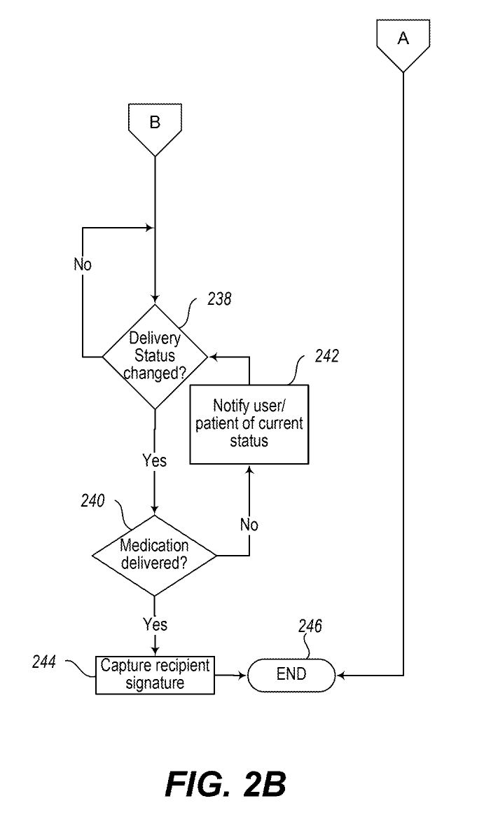

The prescription delivery computing system 120 implements the prescription deliverer 128 to perform prescription delivery. For example, prescription delivery computing system 120 can implement prescription deliverer 128 to perform aspects of method 200 FIGS. 2A-2B. In some implementations, the prescription deliverer 128 interacts with the other computing systems 110, 140, 150, and 160 using vendor-approved or vendor-supplied application programming interfaces.

In some implementations, the prescription delivery computing system 120 implements the prescription deliverer 128 in an automated or autonomous fashion. For example, delivery may be performed periodically not responsive to human prompting or may be performed autonomously. Alternatively, the prescription delivery computing system 120 implements the prescription deliverer 128 responsive to human prompting or according to a defined schedule. In some implementations, the prescription delivery computing system 120 implements the prescription deliverer 128 according to one or more user-defined conditions that specify certain rules, logic, and/or times according to which prescription delivery should (or should not) be performed. In some implementations, prescription deliverer 128 is implemented to perform prescription delivery in the context of a traditional, face-to-face patient/health care provider visit and is, therefore, not limited to the telemedicine context.

In some implementations, the prescription deliverer 128 includes processor-executable instructions stored in or loaded into memory 124 and executed by processor 122. In other implementations, the prescription deliverer 128 includes one or more circuits (e.g., integrated circuits), logic components, or other items of computer hardware configured to implement computer logic or perform other functionality. In other implementations, the prescription deliverer 128 can be implemented using some combination of processor-executable instructions and circuitry.

Network 105 can be any type of communications network, such as a local area network (e.g., intranet), wide area network (e.g., Internet), or some combination thereof and can include any number of wired or wireless links. In general, communication between the components of system 100 via network 105 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

Due to the inherent flexibility of computer-based systems, a great variety of possible configurations, combinations, and divisions of tasks and functionality between and among the components of the system 100 are possible. For instance, tasks shown as being performed at a certain device can instead be performed at other devices. Any combination of general-purpose and special-purpose computing devices can be used.

FIGS. 2A-2B are a flow chart diagram showing a method 200 to perform prescription delivery in a telemedicine system, according to at least one illustrated implementation. In particular, the flow chart diagram of FIGS. 2A-2B is organized to show certain portions of the method 200 that may be performed by or in association with various components of the telemedicine system 100 of FIG. 1.

The method 200 begins at 202. At 204, the prescription delivery computing system 120 hosts or otherwise enables a telemedicine session between the patient and the health care provider. For example, the telemedicine session host 126 may enable a videoconference or other telemedicine session between the patient computing device 110 and the health care provider computing system 140 operated by the health care provider over network 105.

However, in other implementations, the prescription delivery computing system 120 does not host or otherwise enable the telemedicine session. For example, a wholly different computing system from system 120 may host or enable the telemedicine session. Further, as noted above, prescription delivery computing system 120 can perform prescription delivery in a traditional, face-to-face patient/health care provider visit and is not limited to the telemedicine context.

During the telemedicine session, the patient and/or the health care provider may be provided with access to information such as, for example, patient health information stored in a health information database, patient health information stored in database 130, and/or patient health information provided in real-time by one or more medical or fitness devices connected to the patient computing device 110 or connected (e.g., wirelessly) via network 105 (e.g., blood pressure monitors, glucose monitors, pulse monitors, oxygen sensors, step counters, scales, sleep monitoring devices, etc.).

At 205, the prescription delivery computing system 120 may capture the current geographic location of the patient computing device 110 and/or the health care provider computing system 140. The prescription delivery computing system 120 may also capture other information (e.g., IP address) of the patient computing device 110 and/or the health care provider computing system 140, which information may be used to determine the current location of the patient computing device and/or the health care provider computing system 140.

The patient computing device 110 and the health care provider computing system 140 may each determine their respective geographic location. As discussed above, the patient computing device 110 and/or the health care provider computing system 140 may use one or more techniques (e.g., GPS) which include one or more of a variety of types of wireless transmission of electromagnetic signals and/or user input of information. Such geo-location and IP address information may be used by the prescription delivery computing system 120 for prescription delivery purposes (e.g., eligibility determinations, delivery location information) as well as for fraud prevention. As a non-limiting example, the captured location information may be compared to expected patient location information (e.g., billing address, mailing address), which may be used to detect fraud by detecting a mismatch between the two locations.

In some implementations, the prescription delivery computing system 120 may capture evidence that the telemedicine session actually occurred between the patient and a health care provider. For example, the prescription delivery computing system 120 may capture a start time and/or an end time for the telemedicine session between the patient computing device 110 and the health care provider computing system 140. As a more general example, the prescription delivery computing system 120 may capture information which indicates that a real-time communication between the patient computing device 110 and the health care provider computing system 140 occurred. Such information may be used to determine the occurrence and/or duration of the telemedicine session, which may be important for prescription delivery purposes as well as for fraud detection or prevention purposes.

In some implementations, the prescription delivery computing system 120 may capture diagnostic codes for the telemedicine session. Such diagnostic codes may be in any suitable format (e.g., ICD 10 format), and may be used to determine whether or to what extent the telemedicine session is covered by the patient's insurance provider, or may be used to determine whether any medication prescribed during or after the telemedicine session is consistent with the reason for the telemedicine session, which may also help detect fraud.

At 206, the health care provider determines whether any medications are needed. For example, the health care provider computing system 140 may prompt the health care provider to indicate whether prescriptions are needed or whether no prescriptions will be prescribed. If no medications are needed or otherwise to be prescribed, then method 200 can end at 208. However, if one or more medications are needed or otherwise to be prescribed, then method 200 proceeds to 210.

At 210, the system 100 enables the health care provider to issue one or more prescriptions. For example, the prescription delivery computing system 120 and the health care provider computing system 140 can cooperatively operate to provide a user interface on a display of the health care provider computing system 148. The user interface may allow the health care provider to select or otherwise enter one or more medications to prescribe to the patient. The user interface may further allow or require the health care provider to input information such as dosage, quantity, refill information, prescription duration, acceptability of generics, and/or any other information useful in prescribing medications. The health care provider may be required to provide an electronic signature (e.g., by mousing a signature in a signature zone) or other means of validating the prescription (e.g., electronic certificate). The user interface may be provided during and/or after the telemedicine session. As used herein, the term “prescription” includes prescriptions for both controlled medications, treatments, or substances and non-controlled medications, treatments, or substances (e.g., “over-the-counter” medications).

In some implementations, if the health care provider selects or otherwise enters one or more medications for the patient at 210, the system 100 can analyze the one or more medications to assess whether such one or more medications conflict with allergies associated with the patient, existing medications of the patient, and/or concurrently prescribed medications of the patient.

As one example, the medications selected by the health care provider at 210 can be compared to a patient-specific listing of patient allergies and/or medications known to conflict with patient allergies to assess the presence of a prescription/allergy conflict. For example, the patient-specific listing of patient allergies and/or medications known to conflict with patient allergies may be stored in the database 130 or the health information database. As another example, the medications selected by the health care provider at 210 can be compared to a patient-specific listing of existing or concurrently prescribed medications to assess the presence of any pharmaceutical conflicts or contraindications. For example, the patient-specific listing of existing or concurrently prescribed medications may be stored in the database 130 or the health information database.

If the system 100 determines that the one or more medications selected by the health care provider conflict with allergies associated with the patient, existing medications of the patient, and/or concurrently prescribed medications of the patient, the system 100 may provide an alert to the health care provider and/or the patient that explains the nature or identity of such conflict(s). In some implementations, the system 100 may prevent the health care provider from prescribing conflicting medications. In some implementations, the system 100 may permit the health care provider to prescribe conflicting medications only in the instance that consent is obtained from both the health care provider and the patient after providing the conflict alert.

In some implementations, the system 100 may prevent the health care provider from selecting conflicting medications in the first place. As an example, the prescription delivery computing system 120 and the health care provider computing system 140 can cooperatively operate to provide a user interface that allows the health care provider to search for or select (e.g., from a drop down menu) one or more medications. In some implementations, only those medications that do not represent a conflict are available for selection by the health care provider (e.g., included in the drop down menu).

At 212, the system 100 enables the patient to confirm or choose a pharmacy. For example, the prescription delivery computing system 120 and the patient computing device 110 can cooperatively operate to provide a user interface on a display of the patient computing device 110. The user interface may allow the patient to input data that identifies a pharmacy to be used (e.g., input text that identifies a name and/or location of the pharmacy or identify the same on a map). As another example, the system 100 may identify a preferred pharmacy for the patient and request that the patient confirm the preferred pharmacy. For example, the preferred pharmacy may be a pharmacy that has been previously used by the patient in the context of system 100. As another example, the preferred pharmacy may be a pharmacy identified by the patient during an account creation stage. In yet other implementations, at 212, the system 100 may identify one or more local pharmacies based at least in part on a patient address stored in database 130 or based at least in part on a current location of the patient (e.g., as detected by the patient computing device 110 using a suitable geo-location technique (e.g., GPS)). The system 100 may provide the patient with an opportunity to select from among the one or more local pharmacies.

At 214, the system 100 determines whether the one or more prescriptions issued at 210 are respectively eligible for delivery by a proxy. For example, prescription delivery computing system 120 can consult prescription delivery eligibility information stored in database 130 to determine a delivery eligibility for each prescription prescribed at 210. To perform such determination, the prescription delivery computing system 120 can determine a federal scheduling level for each prescription. For example, such information may be stored in database 130 or otherwise accessible over network 105. As another example, to perform eligibility determination, the prescription delivery computing system 120 can determine a narcotic classification for each prescription (e.g., narcotic or non-narcotic). For example, such information may be stored in database 130 or otherwise accessible over network 105. As another example, whether the one or more prescriptions issued are eligible for delivery by a proxy may be dependent at least in part on the current geographic location of the patient, as reported by the patient computing device 110.

Thus, the delivery eligibility of each prescription may be determined based on a set of rules and one or more inputs including, for example, physical location of the patient, federal scheduling level, narcotic classification, legal regime in which patient or pharmacy resides (e.g., patient or pharmacy state or country), health care provider identity, or other factors. For prescriptions that are determined to not be eligible for delivery, method 200 proceeds to 222 and sends the prescription to the pharmacy selected at 212. As an example, the prescription delivery computing system 120 can use an application programming interface to provide, transmit, or otherwise electronically submit the prescription to the pharmacy computing system 160. Other methods or techniques for submitting the prescription to the pharmacy can be used as well.

Thus, if the system 100 determines that prescription is eligible to be prescribed to the patient but is not eligible for delivery, the system will not arrange for delivery of the prescription, but instead will simply send the prescription to the preferred or selected pharmacy. However, for prescriptions that are determined to be eligible for delivery, method 200 proceeds to 216.

Thus, in some implementations, plural prescriptions prescribed by a health care provider for a single patient and/or resulting from a single telemedicine session may be treated differently by the system 100. For example, the system 100 may arrange for delivery of prescriptions eligible for delivery, while the system 100 does not arrange for delivery of prescriptions not eligible for delivery. In other implementations, if at least one of plural prescriptions prescribed by a health care provider for a single patient and/or resulting from a single telemedicine session are not eligible for delivery, then the system 100 does not arrange for delivery of any of such plural prescriptions.

At 216, the system 100 obtains a price quote for delivering the prescriptions from the pharmacy to the patient's home address (or other patient-associated address). As an example, the prescription delivery computing system 120 can communicate with one or more delivery service computing systems 150 to respectively obtain one or more price quotes for delivery services. For example, the prescription delivery computing system 120 can use an application programming interface to obtain a price quote from a delivery service computing system 150 in real-time. The prescription delivery computing system 120 can provide information such as pharmacy address, patient delivery address, size of the prescriptions to be delivered, weight of the prescriptions to be delivered, or other information to obtain the price quote.

At 218, the system 100 determines whether the patient and the pharmacy are located in a delivery zone. As discussed above, the geographic location of the patient may be determined using geo-location information provided by the patient computing device 110. For example, if price quotes are unable to be obtained from one or more delivery service computing systems 150, then the system 100 may determine that either the patient or the pharmacy are not located in a delivery zone. However, if one or more price quotes are able to be obtained, then the system may determine that the patient and the pharmacy are located within a delivery zone. Thus, in some implementations block 218 may be included within the scope of block 216. Alternatively, at 218, the system 100 may check the patient's or pharmacy's address against one or more delivery zones stored in database 130 to determine whether the patient and the pharmacy are located in a delivery zone.

If the system 100 determines at 218 that the patient and the pharmacy are located in a delivery zone, the method 200 proceeds to 220. However, if the system 100 determines at 218 that either the patient or the pharmacy are not located in a delivery zone, then method 200 proceeds to 222 and sends the prescription to the pharmacy selected at 212. Thus, if the system 100 determines that prescription is not capable of being delivered, the system will not arrange for delivery of the prescription, but instead will simply send the prescription to the preferred pharmacy. However, for prescriptions that are determined to be capable of being delivered, method 200 proceeds to 220.

At 220, the system 100 provides the price quote obtained at 216 to the patient for patient approval. For example, the prescription delivery computing system 120 and the patient computing device 110 may cooperatively operate to provide a user interface on a display of the patient computing device 110. The user interface may indicate the price quote and provide the patient with an ability to either accept or deny the delivery services price quote. The patient may be required to provide an electronic signature (e.g., by mousing a signature in a signature zone) or other means of confirming acceptance of the price quote and/or confirming his or her identity (e.g., electronic certificate). In some implementations, information (e.g., password, IP address, authentication token) obtained from the patient computing device 110 may be used to verify the identity of the patient ordering the prescription. In some implementations, other options may be provided, including, for example, selection of a different pharmacy, selection of an alternate delivery address, selection of an alternate delivery time, or selection of an alternate delivery provider. In some implementations, multiple price quotes may be retrieved and provided to the patient and the patient may select one or none of the multiple provided price quotes.

If the patient does not accept the price quote at 220, then at 222 the system 100 sends the prescription to the pharmacy selected at 212. Thus, if the patient does not accept the price quote, the system 100 will not arrange for delivery of the prescription, but instead will simply send the prescription to the preferred pharmacy.

However, if the patient accepts the price quote at 220, then at 224 the system may check to see if the delivery provider accepts payments on behalf of the patient (“on behalf payments”). If the delivery provider accepts “on behalf” payments, the system will send the prescription to the pharmacy at 236. Furthermore, at 234, the system 100 will compose a delivery order with the patient's name, origin address, delivery address, and/or other information (e.g., birth date) to the appropriate delivery service or courier. For example, the prescription delivery computing system 120 can use an application programming interface to request, send, or otherwise electronically submit an delivery order to the delivery service computing system 150 operated by the delivery service from which the accepted price quote was obtained. The delivery service will then retrieve the prescription from the pharmacy, make a payment on behalf of the patient, and deliver the prescription to the patient's address.

Returning to 224, if the delivery provider does not accept “on behalf” payments, at 226 the system will send the prescription to the pharmacy. At 228, the system checks to determine whether the prescription delivery system operates a call center. At 230, if the prescription delivery system operates a call center, the system may instruct the call center to call the selected pharmacy and to provide payment on the phone and to obtain a confirmation from the pharmacy. The payment provided to the pharmacy may be charged back to the patient or to another payer, such as a private or public insurance provider. At 232, if the prescription delivery system does not operate a call center, the system may instruct the patient to call the selected pharmacy and to provide payment over the phone and obtain a confirmation from the pharmacy. Other systems may be used to autonomously or manually provide payment to the pharmacy for the one or more prescriptions.

Once payment has been provided by the patient (act 232), via the call center (act 230), or through another autonomous and/or manual method, the system 100 may compose a delivery order at 234, as discussed above.

At 238, once the delivery order has been placed with the prescription delivery service, the system 100 may monitor the delivery status of the medication. For example, at 240 and 242, the system 100 may periodically notify the patient or other entity of the current delivery status (e.g., “out for delivery,” “order placed”) and/or provide one or more delivery time estimates (e.g., within 45 minutes, at 4:00 PM). Once the medication has been delivered, at 244 the system 100 may capture the signature of the recipient of the medication. For example, the courier for the delivery service may carry a portable computing device which permits a recipient (e.g., patient) to electronically sign to confirm receipt of the medication. Such confirmation may be used as evidence of delivery and may also be used to prevent or reduce the possibility of fraud.

In some instances, the identity of the recipient of the medication may be further verified using information obtained from the patient computing device 110. For example, the patient (or an associated person) may be provided with unique identifier (e.g., alphanumeric identifier, machine-readable symbol) which may be viewed by the courier and/or read by a portable computing device (e.g., smartphone) of the courier. Such patient identity verification may also be implemented using one or more wireless technologies (e.g., RFID, NFC, Bluetooth®) between the patient computing device 110 and another computing device (e.g., prescription delivery computing system 120, delivery service computing device 140, computing devices communicatively coupled to the system 100).

In some implementations, the prescription delivery computing system 120 may intermediate one or more of a transaction between the patient and the delivery service; a transaction between the patient and the pharmacy; and a transaction between the delivery service and the pharmacy. For example, financial account information, such as credit card information, may be stored for the patient in the database 130. The prescription delivery computing system 120 may use the stored financial account information to automatically transact with the pharmacy and/or the delivery service upon receiving approval from the patient.

Those of skill in the art will recognize that many of the methods or algorithms set out herein may employ additional acts, may omit some acts, and/or may execute acts in a different order than specified.

The various implementations described above can be combined to provide further implementations. U.S. Provisional Patent Application Ser. No. 62/140,378 filed Mar. 30, 2015, is incorporated herein by reference, in its entirety. Aspects of the implementations can be modified, if necessary, to employ systems, circuits and concepts of the various patents, applications and publications to provide yet further implementations.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A computer-implemented method in a telemedicine system that includes at least a first patient computing device, a health care provider computing system, and a prescription delivery computing system that includes at least one processor, the method comprising:
receiving, by the prescription delivery computing system from the health care provider computing system, data that identifies one or more prescriptions issued by a health care provider that operates the health care provider computing system to a patient that operates the first patient computing device, the one or more prescriptions resultant from a live telemedicine session conducted between the patient and the health care provider via the first patient computing device and the health care provider computing system;
receiving, by the prescription delivery computing system, data that verifies whether the telemedicine session occurred between the patient and the health care provider;
determining, by the prescription delivery computing system, whether the one or more prescriptions are respectively eligible to be delivered to the patient based at least in part on the received data that verifies whether the telemedicine session occurred between the patient and the health care provider;
for the one or more prescriptions that are eligible to be delivered to the patient, obtaining, by the prescription delivery computing system, a price quote for delivery services to deliver the one or more prescriptions from a pharmacy to the patient, the price quote obtained from a delivery service computing system;
providing, by the prescription delivery computing system, the price quote for the delivery services to the patient computing device for approval by the patient;
responsive to receiving patient input data indicative of patient approval of the price quote for the delivery services, arranging, by the prescription delivery computing system, for the delivery services to be performed; and
transmitting, by the prescription delivery computing system, data that describes the one or more prescriptions to the pharmacy.

2. The computer-implemented method of claim 1 wherein receiving information that verifies whether the telemedicine session occurred between the patient and the health care provider comprises receiving information which indicates an occurrence of a real-time communication between the patient computing device and the health care provider computing system.

3. The computer-implemented method of claim 1, further comprising:
receiving, by the prescription delivery computing system, data that identifies a current geographical location of the patient computing device, wherein,
determining whether the one or more prescriptions are respectfully eligible to be delivered to the patient comprises determining whether the one or more prescriptions are respectfully eligible to be delivered to the patient based at least in part on the received data that identifies the current geographical location of the patient computing device.

4. The computer-implemented method of claim 3 wherein receiving data that identifies a current geographical location of the patient computing device comprises receiving information relating to one or more of an Internet Protocol (IP) address, a media access control (MAC) address, an RFID identifier, a hardware embedded identifier, a software embedded identifier, Wi-Fi® location data, cell tower location data, a device fingerprint, or device GPS data.

5. The computer-implemented method of claim 1, further comprising:
providing, by the health care provider computing system, a menu of available medications to the health care provider at least one of during and after the telemedicine session.

6. The computer-implemented method of claim 1, further comprising:
determining, by the prescription delivery computing system, whether the one or more prescriptions conflict with one or more of allergies associated with the patient, existing medications of the patient, and concurrently prescribed medications of the patient; and
when it is determined that the one or more prescriptions conflict with one or more of allergies associated with the patient, existing medications of the patient, and concurrently prescribed medications of the patient, providing, by the prescription delivery computing system, an alert to the health care provider computing system.

7. The computer-implemented method of claim 1, further comprising:
receiving, by the prescription delivery computing system, patient input data that identifies the pharmacy.

8. The computer-implemented method of claim 1, further comprising:
identifying, by the prescription delivery computing system, a preferred pharmacy for the patient; and
receiving, by the prescription delivery computing system, patient input data that confirms the preferred pharmacy.

9. The computer-implemented method of claim 8 wherein identifying, by the prescription delivery computing system, a preferred pharmacy for the patient comprises identifying, by the prescription delivery computing system, a previously used pharmacy for the patient.

10. The computer-implemented method of claim 8 wherein identifying, by the prescription delivery computing system, a preferred pharmacy for the patient comprises identifying, by the prescription delivery computing system, one or more local pharmacies based at least in part on a patient address or a current location of the patient computing device.

11. The computer-implemented method of claim 8 wherein identifying, by the prescription delivery computing system, a preferred pharmacy for the patient comprises querying, by the prescription delivery computing system, a patent account database to identify the preferred pharmacy stored in a patient account associated with the patient.

12. The computer-implemented method of claim 1 wherein obtaining, by the prescription delivery computing system, a price quote for delivery services to deliver the one or more prescriptions from a pharmacy to the patient comprises communicating, by the prescription delivery computing system, in real-time with a delivery service computing system to obtain the price quote for the delivery services.

13. The computer-implemented method of claim 1 wherein determining, by the prescription delivery computing system, whether the one or more prescriptions are respectively eligible to be delivered to the patient comprises determining, by the prescription delivery computing system, a federal scheduling level of each of the one or more prescriptions.

14. The computer-implemented method of claim 1 wherein determining, by the prescription delivery computing system, whether the one or more prescriptions are respectively eligible to be delivered to the patient comprises determining, by the prescription delivery computing system, a narcotic classification of each of the one or more prescriptions.

15. The computer-implemented method of claim 1 wherein determining, by the prescription delivery computing system, whether the one or more prescriptions are respectively eligible to be delivered to the patient comprises querying, by the prescription delivery computing system, a database to determine an eligibility status for each of the one or more prescriptions.

16. The computer-implemented method of claim 1, further comprising:
responsive to receiving patient input data indicative of patient disapproval of the price quote for the delivery services, transmitting, by the prescription delivery computing system, data that describes the one or more prescriptions to the pharmacy but not arranging, by the prescription delivery computing system, for the delivery services to be performed.

17. The computer-implemented method of claim 1, further comprising:
serving, by the prescription delivery computing system, as an intermediary for at least one of a first transaction between the patient and the pharmacy and a second transaction between the patient and a delivery service that performs the delivery services.

18. The computer-implemented method of claim 1 wherein obtaining, by the prescription delivery computing system, a price quote for delivery services to deliver the one or more prescriptions from a pharmacy to the patient comprises using, by the prescription delivery computing system, an application programming interface to obtain the price quote for the delivery services from a delivery service server computing device.

19. The computer-implemented method of claim 1 wherein receiving, by the prescription delivery computing system from the health care provider computing system, data that identifies one or more prescriptions issued by a health care provider comprises receiving, by the prescription delivery computing system from the health care provider computing system, electronic records that identify the one or more prescriptions issued by a health care provider.

20. The computer-implemented method of claim 1, further comprising:
transmitting, by the prescription delivery computing system to the patient computing device, data which indicates status information for the scheduled delivery service.

21. A telemedicine system, comprising:
at least a first patient computing device;
a health care provider computing system; and
a prescription delivery computing system that includes at least one processor and a non-transitory processor-readable medium that stores at least one of instructions or data that, when executed by the at least one processor, cause the prescription delivery computing system to:
receive from the health care provider computing system data that identifies one or more prescriptions issued by a health care provider that operates the health care provider computing system to a patient that operates the first patient computing device, the one or more prescriptions resultant from a telemedicine session conducted between the patient and the health care provider via the first patient computing device and the health care provider computing system;
receive data that verifies whether the telemedicine session occurred between the patient and the health care provider;
determine whether the one or more prescriptions are respectively eligible to be delivered to the patient based at least in part on the received data that verifies whether the telemedicine session occurred between the patient and the health care provider;
for the one or more prescriptions that are eligible to be delivered to the patient, obtain a price quote for delivery services to deliver the one or more prescriptions from a pharmacy to the patient, the price quote obtained from a delivery service computing system;
provide the price quote for the delivery services to the patient for approval;
responsive to receiving patient input data indicative of patient approval of the price quote for the delivery services, arrange for the delivery services to be performed; and
transmit data that describes the one or more prescriptions to the pharmacy.

22. The telemedicine system of claim 21 wherein the instructions or data, when executed by the at least one processor, cause the prescription delivery computing system to:
receive information which indicates an occurrence of a real-time communication between the patient computing device and the health care provider computing system.

23. The telemedicine system of claim 21 wherein the instructions or data, when executed by the at least one processor, cause the prescription delivery computing system to:
receive data that identifies a current geographical location of the patient computing device; and
determine whether the one or more prescriptions are respectfully eligible to be delivered to the patient based at least in part on the received data that identifies the current geographical location of the patient computing device.

24. The computer-implemented method of claim 23 wherein the instructions or data, when executed by the at least one processor, cause the prescription delivery computing system to:
receive information relating to one or more of an Internet Protocol (IP) address, a media access control (MAC) address, an RFID identifier, a hardware embedded identifier, a software embedded identifier, Wi-Fi® location data, cell tower location data, a device fingerprint, or device GPS data.

25. A prescription delivery computing system, comprising:
at least one processor; and
a non-transitory processor-readable medium that stores at least one of instructions or data that, when executed by the at least one processor, cause the prescription delivery computing system to:
receive from a health care provider computing system data that identifies one or more prescriptions issued by a health care provider that operates the health care provider computing system to a patient that operates a first patient computing device, the one or more prescriptions resultant from a telemedicine session conducted between the patient and the health care provider via the first patient computing device and the health care provider computing system;
determine whether the one or more prescriptions are respectively eligible to be delivered to the patient;
for the one or more prescriptions that are eligible to be delivered to the patient, obtain a price quote for delivery services to deliver the one or more prescriptions from a pharmacy to the patient, the price quote obtained from a delivery service computing system;
provide the price quote for the delivery services to the patient for approval;
responsive to receiving patient input data indicative of patient approval of the price quote for the delivery services, arrange for the delivery services to be performed; and
transmit data that describes the one or more prescriptions to the pharmacy.

26. A computer-implemented method in a telemedicine system that includes at least a first patient computing device, a health care provider computing system, and a prescription delivery computing system that includes at least one processor, the method comprising:
receiving, by the prescription delivery computing system from the health care provider computing system, data that identifies one or more prescriptions issued by a health care provider that operates the health care provider computing system to a patient that operates the first patient computing device, the one or more prescriptions resultant from a live telemedicine session conducted between the patient and the health care provider via the first patient computing device and the health care provider computing system;
determining, by the prescription delivery computing system, whether the one or more prescriptions are respectively eligible to be delivered to the patient;
for the one or more prescriptions that are eligible to be delivered to the patient, obtaining, by the prescription delivery computing system, a price quote for delivery services to deliver the one or more prescriptions from a pharmacy to the patient, the price quote obtained from a delivery service computing system;
providing, by the prescription delivery computing system, the price quote for the delivery services to the patient computing device for approval by the patient;
responsive to receiving patient input data indicative of patient approval of the price quote for the delivery services, arranging, by the prescription delivery computing system, for the delivery services to be performed; and
transmitting, by the prescription delivery computing system, data that describes the one or more prescriptions to the pharmacy.
